(19) United States
(12) Patent Application Publication
(10) Pub. No.: US 2002/0152812 A1
(43) Pub. Date: Oct. 24, 2002

(54) Miniature two-cell accelerometer

(76) Inventors: Paul David Featonby, Paris (FR); Herve Baudry, Argenteuil (FR); Karine Petroz, Paris (FR)

Correspondence Address: LARSON & TAYLOR, PLC, 1199 NORTH FAIRFAX STREET, SUITE 900, ALEXANDRIA, VA, 22314, US

(21) Appl. No.: 10/080,521

(22) Filed: Feb. 25, 2002

(30) Foreign Application Priority Data
Feb. 26, 2001 (FR) 01 02575

(51) Int. Cl. G01C 19/00

(52) U.S. Cl. 73/504.12

(57) ABSTRACT

A flat monolithic accelerometer detector comprises a body (12) having a base (16) and two measurement cells each having a seismic mass (24a-24b) connected to the base via a joint enabling the mass to turn about an axis perpendicular to a sensing axis of the detector and each having a vibrating beam force sensor connecting the mass to the base, the cells being placed in such a manner that when one of the beams is subjected to a traction force due to an acceleration along the sensing axis, the other beam is subjected to a compression force of the same magnitude, the cells being disposed in opposite directions and symmetrically about an axis of the base for fixing to a support (18) whose acceleration is to be measured. Each beam is constituted by at least two parallel blades (26, 28) that are at different distances from the joint, with the two blades in a given cell being connected to the seismic mass of that cell via a common hinge.

The present invention relates to miniature accelerometers of the type comprising seismic masses, also referred to as proof masses, that are not returned to an equilibrium position by servo-control.

They differ from servo-controlled pendulous accelerometers which can be accurate but are very expensive, including electrostatic or electromagnetic control means for returning the seismic mass into a determined position. Such apparatuses implementing closed-loop operation are complex. Furthermore, in most cases they use analog electronics.

Miniature accelerometers with non-servo-controlled pendulous masses are already known, in which each pendulous mass is biased towards a rest position by a connection with a base via a pair of vibrating beams placed so that acceleration along a sense axis creates traction stress in one beam and compression stress in the other. The two vibrating beams are made of piezoelectric material and they are provided with electrodes for causing the beams to vibrate at their resonant frequency. Variation in the resonant frequency of the beams is representative of the applied acceleration. By using two beams, one in traction and the other in compression, it is possible to linearize behavior by using their resonant frequencies differentially.

The flat structure of that configuration (thickness generally less than 1 millimeter (mm) for plane dimensions that can be up to about 1 centimeter (cm)) make it possible for manufacture to be made simple and low cost, e.g. by using chemical etching methods. Manufacture can be collective, i.e. numerous accelerometers can be manufactured simultaneously on a single wafer of material which is generally piezoelectric, but which could be silicon.

Those apparatuses enable a digital signal to be obtained. They are simple to make. Until now, the accuracy they provide has been insufficient in some applications.

Proposals have also been made (FR-A-2 685 964 and 2 784 752) for monolithic miniature accelerometers capable of being manufactured at low cost.

In an accelerometer of the kind as described in document FR-A-2 685 964, the or each beam is simple, thereby giving rise to problems of isolation that can be compensated only in part by means of a mechanical filter structure which occupies surface area and adds flexibility to the assembly, which means that the first modes of vibration of the structure run the risk of lying in the range of frequencies that might be encountered in potential applications.

An accelerometer detector is also known (FR-A2 784 752) having a monolithic body presenting a fixed portion and two cells having seismic masses situated on either side of the fixed portion, being connected to the fixed portion via joints that enable movement about an axis perpendicular to the sensing axis, and vibrating beam sensors each connecting one of the masses to the central portion and mounted in such a manner that when one of the beams is subjected to a traction force due to an acceleration along the sensing axis, the other beam is subjected to a compression force of the same magnitude.

That disposition suffers from defects, due in particular to the feet of the cells supporting the ends of the vibrating beams being directly interconnected by a cross-member belonging to the fixed portion. That disposition leads to mechanical coupling which causes the vibration frequencies of the beams to become locked in the event of low levels of acceleration, i.e. it leads to a blind zone. In practice, it is necessary for the beams to be given resonant frequencies that are very different, and as a result common mode compensation is partial only and performance is degraded.

One solution for isolating the vibrations of the beams in two cells, each cell having a mass and a beam disposed facing in opposite directions and symmetrically about an axis, consists in making up each beam out of two blades that vibrate in phase opposition, i.e. like the two limbs of a tuning fork. The stresses that act on the two blades cancel mutually.

With a thick, massive detector, this separation can be achieved by splitting the beam so as to give rise to two blades that lie in the same plane and that are at the same distance from the joint. However such a structure is very difficult to implement when making miniature detectors that are very thin, well below one millimeter (mm) thick, of the kind that are manufactured by anisotropic etching techniques. Manufacture is performed by etching in one direction only. To split the blade in two, it is necessary to etch at 90° to that direction. It is preferable to use two parallel blades at different distances from the joint. The two blades can have substantially the same thickness as the seismic mass or they can be thinner in order to increase sensitivity. However the lever arm whereby the mass acts on each beam is not the same for both of the associated blades, thus giving rise to different stresses in the two blades.

The present invention seeks in particular to provide a thin miniature accelerometer detector that satisfies practical requirements better than previously known detectors, in particular in that it presents a high degree of linearity and avoids problems of coupling and stress difference, while nevertheless remaining low in cost, particularly when made using techniques that are suitable for collective manufacture.

To this end, the invention provides in particular a flat monolithic accelerometer detector comprising a body having a base and two measurement cells each having a seismic mass connected to the base via a joint enabling the mass to turn about an axis perpendicular to a sense axis of the detector, and also having a vibrating beam force sensor connecting the mass to the base, the cells being placed in such a manner that when one of the beams is subjected to a traction force due to an acceleration along the sensing axis, the other beam is subjected to a compression force of the same magnitude, the cells being disposed in opposite directions and symmetrically about an axis, which may be the axis of means for fixing the base to a structure whose acceleration is to be measured, and each beam being constituted by at least two parallel blades at different distances from the joint, the two blades in a given cell being connected to the seismic mass of the cell via a common hinged connection.

The hinged connection can be constituted by a narrowed portion of a common foot for the two blades.

A simple but non-exclusive mounting method consists in securing the base to a support that presents a projection on which one face of the base is fixed. It is possible to make the body, the force sensors, and even the support in monolithic form, leaving very small clearance, which may be only a few tens of microns (μm) thick between the seismic masses and the support. Such a structure has the additional advantage that the support then constitutes an abutment that limits deformation in a direction orthogonal to the sensing axis and avoids the detector being destroyed.

The detector is generally made of a piezo-resistive material (a ceramic, or above all quartz). Nevertheless, it is also possible to make the detector out of silicon, which means that the beams must be excited either by locally depositing a piezoelectric layer, or else by some other physical method (e.g. capacitive or magnetic), or by a combination of such methods.

As mentioned above, the detector is of small thickness (often about 500 μm). A suitably-selected stiffness ratio makes it possible to place the first vibration mode of the detector structure so that it is orthogonal to the sensing axis with a frequency that lies outside the spectra that are of use in potential applications, while not thereby diminishing sensitivity along the sensing axis.

The blades will often have parallel edges and be of constant thickness, for reasons of ease of manufacture. Nevertheless, it is also possible for the blades to be of varying right section. Given that the usual methods of manufacture by chemical etching are poorly adapted to varying the width of the blades (i.e. to providing variation in the direction orthogonal to the plane of the body), such variation in section will generally be provided in the thickness direction. Variation can be made to be continuous, by giving the edges of the blade a curved shape that reduces the section in the middle. It can also be obtained by providing chamfers. Providing chamfers is particularly suitable when using quartz detectors having a crystal structure that is well adapted to forming chamfers at 60° to the blade direction or to the orthogonal direction. In contrast, a stepped shape with shoulders at 90° suffers from the drawback of giving rise to local stress concentrations. A varying shape is equally usable for a beam constituted by a single blade or by two blades lying in the same plane. It is also advantageous for the sides of the hinges and of the joints to slope at 60° relative to their axes.

The above characteristics and others will appear better on reading the following description of particular embodiments, given as non-limiting examples. The description refers to the accompanying drawings, in which:

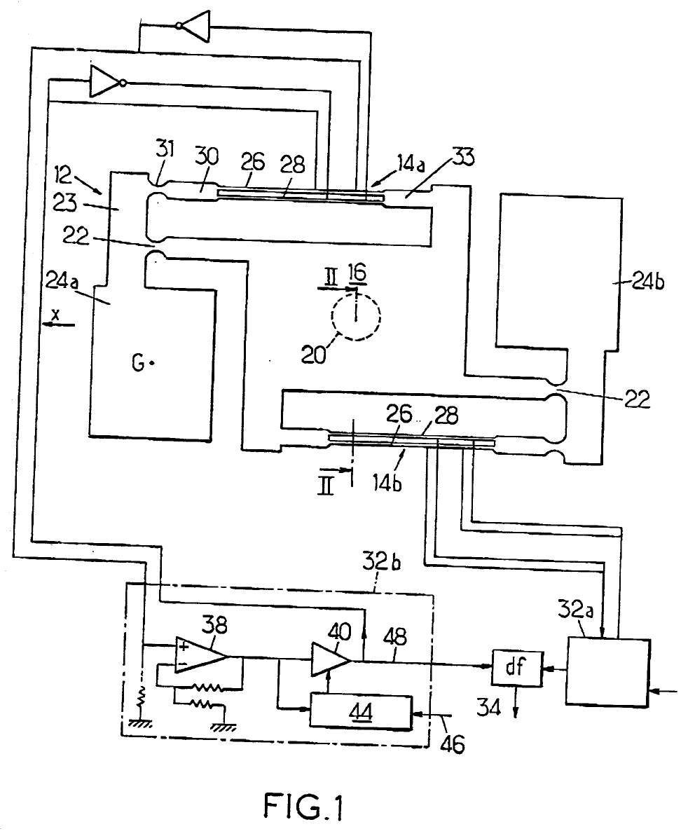

FIG. 1 (which is not to scale for reasons of clarity) is a simplified perspective view of a detector constituting a first embodiment;

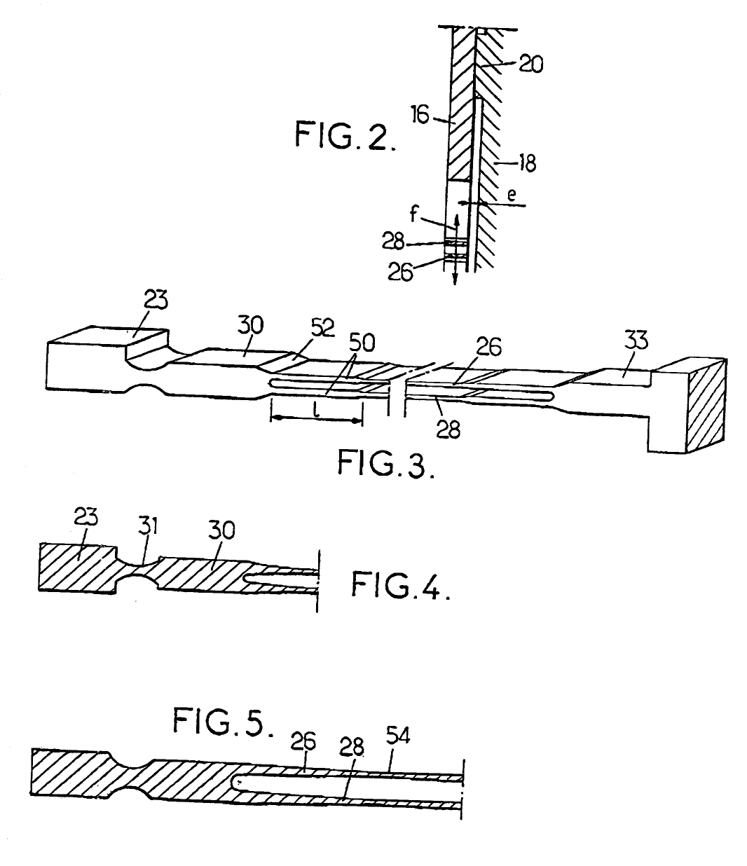

FIG. 2 is a cross-sectional view along line II-II of FIG. 1;

FIGS. 3, 4, and 5 are detail views on a larger scale showing possible shapes for the blades in the FIG. 1 embodiment; and

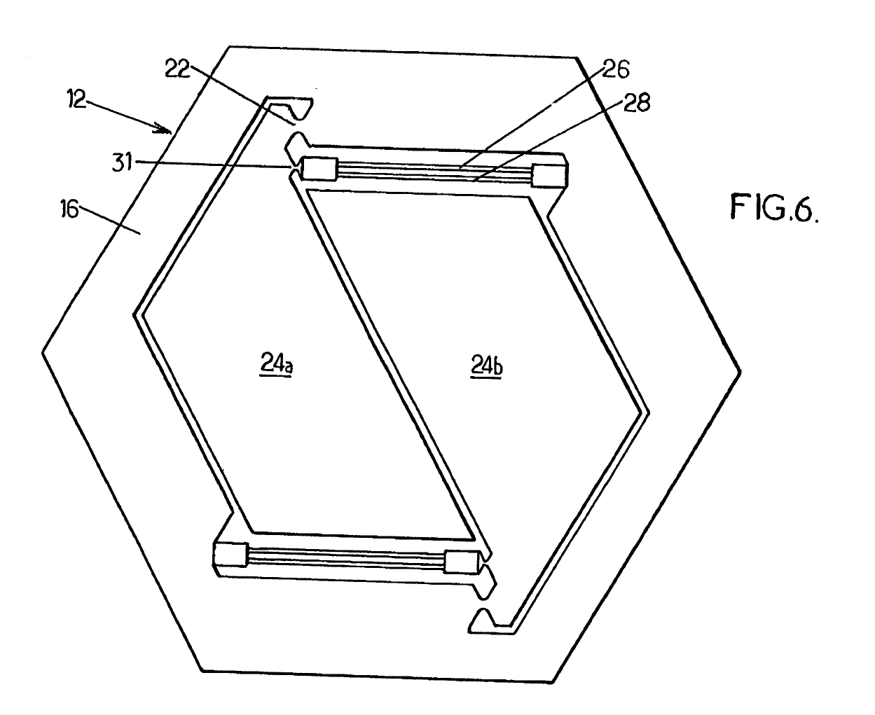

FIG. 6 is similar to FIG. 1 and shows a variant embodiment using 60° chamfers or angles.

The accelerometer detector shown diagrammatically in FIGS. 1 and 2 is of monolithic structure. It can be considered as having a two-cell body 12 with force sensors 14a and 14b each constituted by a respective “beam” formed by a pair of vibrating blades connected to a circuit for measuring the difference between the resonant frequency of the blades in one cell and that of the blades in the other cell.

The body 12 has a base 16 for fixing to the structure whose acceleration is to be measured. The fixing can then be located at the center of symmetry of the detector. In the examples shown in FIGS. 1 and 2, the body is secured to a support 18 by sticking its central portion to a projection 20 from the support. Advantageously, the clearance e left between the support and the facing large face of the body 12 is very small, for example a few Am for a flat miniature accelerometer that is a few hundred μm thick. The support then constitutes an abutment limiting transverse displacement of the body.

The body and the support can together constitute a monolithic assembly made using conventional chemical etching techniques. In most cases the assembly is made of quartz which has the advantage of being piezoelectric. In a variant embodiment, the assembly is made of silicon.

The base 16 is connected via joints 22 to two proof or seismic masses 24a and 24b disposed symmetrically about an axis which can correspond to a single fixing zone for the base. The joint means are integral with the seismic masses and with the base.

In the example shown, each seismic mass 24a and 24b is connected to the base 16 via a single joint 22 that is orthogonal to the sensing axis X and that forms a hinge 22, and also via the corresponding sensor 14a or 14b. The joint 22 is placed on an arm 23 extending the massive portion of the seismic mass 24a or 24b and is situated between the massive portion and the corresponding sensor 14a or 14b so as to generate a lever effect whereby the movement of the sensor attachment is smaller than the movement of the center of gravity G of the seismic mass. Because of this large lever arm difference and because of the hinge, the “beam” remains permanently aligned substantially on the sensing axis and works in traction compression. This ensures that the beams do not have any unfavorable influence on the resonant mode of the structure along the sensing axis.

Each sensor 14a is constituted by two parallel blades 26 and 28. In the example shown, the thickness of the blades in the plane of FIG. 1 is less than the width thereof in the plane of FIG. 2; it is also possible to use blades of square section.

The blades 26 and 28 are designed to vibrate in phase opposition in the direction shown by arrow f in FIG. 2. Because of their relative disposition, they are at different distances from the joint 22. Consequently, if they were connected independently to the arm 23, they would be subjected to different stresses in the event of acceleration along the sensing axis. This defect is avoided in the context of the invention by connecting together the two adjacent ends of the two parallel blades via a foot 30 which is in turn connected to the arm 23 via a hinge or hinged connection 31 parallel to the joint 22. The hinge 31 is advantageously placed relative to the joint 22 in such a manner that the plane which contains the finished portions thereof also contains the center of gravity G of the corresponding seismic mass.

The ends of the two blades opposite from the foot 30 can likewise be interconnected and connected to the central portion 16 via a second foot 33.

The blades 26 and 28 can be thin blades of constant section as shown in FIGS. 1 and 2. It is advantageous for the blades and the joints to be made in such a manner that the first oscillation mode of the structure has a frequency which is very high relative to the frequency range required for the accelerations to be measured. In addition, the flexibility of the blades is advantageously sufficient to avoid giving rise to any appreciable return force.

For an accelerometer detector for use in missiles, the spectrum beyond which the first vibration mode of the structure needs to be located generally terminates around 3 kilohertz (kHz).

The term “blade” should be interpreted broadly as designating any elongate sensor capable of using the piezoelectric effect, the piezoresistive effect, or in a less advantageous structure a capacitive effect for detection purposes, and the effect must give rise to a signal which is representative of the longitudinal traction and compression stresses.

Any acceleration along the sensing axis X causes one of the beams to be put under longitudinal tension and the other under compression. A circuit connected to electrodes for exciting the blades to resonant vibration and also connected to electrodes for detecting the resonant frequency serves to determine the difference between the common resonant frequency of the two blades of one beam and that of the other beam, and to deduce acceleration therefrom.

The above-described structure presents numerous advantages. The sensing axis does not change significantly in orientation when the seismic masses move. Coupling between the sensing axes of the two cells is very weak and coupling between the two oscillators is small. The two blades making up a single beam are subjected to the same stresses.

The detector can be manufactured in particular by wet etching or by “ion track” dry etching followed by chemical etching.

When the body is made of non-piezoelectric material, e.g. of silicon, the beams can be excited by locally depositing a piezoelectric material, or by some other physical method such as a capacitive or a magnetic method.

Merely by way of example, FIG. 1 shows a circuit that can be associated with the beams 14a and 14b for measuring the natural frequency of each beam and for deducing acceleration therefrom. The circuit comprises two oscillators 32a and 32b, with only the second oscillator being shown in detail. It also comprises a module 34 for measuring the difference between the frequencies of the output signals from the oscillators. Each oscillator is designed to maintain the current applied to the beam electrodes at a constant amplitude, and the electrodes can be of the structure described in one of the above-mentioned patent applications in the name of the Applicant. The oscillator 32b shown in FIG. 1 comprises an amplifier 38 whose feedback loop contains the electrodes for exciting the two blades of the beam 14b to resonance together with a controlled gain amplifier 40. Inverters enable the blades 26 and 28 to be caused to vibrate in phase opposition. The gain of the amplifier 40 is controlled by a module 44 which receives a reference voltage on an input 46 and which compares it with the voltage output by the amplifier 38. Because the current in the blade electrodes is maintained at a constant magnitude, as set by the reference voltage, frequency variations due to phase are canceled.

The outputs from the two oscillators are applied to the circuit 34 which determines the difference df between the resonant frequencies and which deduces acceleration therefrom. This measurement can be performed digitally, because a frequency can easily be transformed into a series of pulses at a repetition frequency which corresponds to the resonant frequency.

Other electronic configurations are possible.

In the modified embodiment of the sensor shown in FIG. 3, where elements corresponding to those shown in FIG. 1 are given the same reference numerals, the blades are identical to each other, but they have a cross-section that is varied by varying in thickness. For this purpose, each blade is of constant width presents a central portion of reduced thickness and two end portions 50 of somewhat greater thickness. The connections between the end portions 50 and respectively the central portions and the feet 30 and 33 are advantageously formed via chamfers so as to avoid stress concentrations and that are easy to make, particularly for a beam made of quartz which is well suited to chamfers 52.

The length λ of the portions 50 and the thicknesses can be optimized on the basis of finite element computations that take account of stress distribution during vibration.

In the modified embodiment shown in FIG. 4, both faces of each blade present curvature for reducing thickness in the center. Instead of being symmetrical in shape as shown in FIG. 4, it is possible to use a shape that is not symmetrical, with only one of the two faces being curved.

In the example shown in FIG. 5, each blade is in the form of two chamfers, the two chamfers meeting in the midplane 54 of the blades 26 and 28.

The invention can be implemented in numerous other ways, using a material that is piezoelectric or otherwise, monolithic or composite. Furthermore, and in particular when the detector is made monolithically with the support 18, it is possible in a single operation to make groups each comprising two detectors having crossed sensing axes on a single semiconductor wafer. It is also possible on a single wafer to associate one or two flat accelerometer detectors of the kind shown with a gyro sensor, that is also flat.

In the modification shown in FIG. 6 (where elements corresponding to elements of FIG. 1 are designated by the same reference numerals), the body 12 is hexagonal in outline, thus making it possible in particular to achieve optimum utilization of a silicon or quartz wafer when collective manufacture is used. The seismic masses 24a and 24b have edges parallel to sides of the hexagonal outline. The center of gravity of each mass still lies in the plane containing the axes of the corresponding hinged connection and joint.

1/ A flat monolithic accelerometer detector comprising a body (12) having a base (16) for fixing to a support (18) whose acceleration is to be measured, and two measurement cells each having a seismic mass (24a-24b) connected to the base via a joint enabling the mass to turn about an axis perpendicular to a sensing axis of the detector, and also having a vibrating beam force sensor connecting the mass to the base, the cells being placed in such a manner that when one of the beams is subjected to a traction force due to an acceleration along the sensing axis, the other beam is subjected to a compression force of the same magnitude, the cells being disposed in opposite directions and symmetrically about an axis, each beam being constituted by at least two parallel blades at different distances from the joint, the two blades in a given cell being connected to the seismic mass of the cell via a common hinge.

2/ A detector according to claim 1, characterized in that the joints and the force sensors are provided in such a manner that the first vibration mode of the mass structure lies in a direction that is orthogonal to the sensing axis of the detector.

3/ A detector according to claim 1, characterized in that said base is secured via one face to a projection from the support.

4/ A detector according to claim 3, characterized in that the seismic masses are separated from the support by clearance that is small relative to the thickness of the body.

5/ A detector according to claim 1, characterized in that the hinge and the joint are in alignment with the center of gravity of the corresponding seismic mass.

6/ A detector according to claim 1, characterized in that the blades have parallel edges and are of constant thickness.

7/ A detector according to claim 1, characterized in that the blades are of varying right section.

8/ A detector according to claim 7, characterized in that the variation in the right section of the blades takes place in the thickness direction and is obtained by giving the two large faces of a blade a curved shape for reducing the right section in the middle of the blade or obtained by means of chamfers.

9/ A detector according to claim 7, characterized in that the blades are made of quartz and the chamfers are at 60° to the blade direction or to the direction orthogonal thereto.

10/ A detector according to claim 1, characterized in that the hinges and the joints have portions at 60° to the axis.
